(19) United States
(12) Patent Application Publication
(10) Pub. No.: US 2006/0171775 A1
(43) Pub. Date: Aug. 3, 2006

(54) Articulated torque rod with elastomer retainer

(76) Inventors: Ronald McLaughlin, Maumee, OH (US); Matthew Wieczorek, Norwalk, OH (US)

Correspondence Address: HARNESS, DICKEY & PIERCE, P.L.C., P.O. BOX 828, BLOOMFIELD HILLS, MI, 48303, US

(21) Appl. No.: 11/047,538

(22) Filed: Jan. 31, 2005

(51) Int. Cl. F16C 11/00

(52) U.S. Cl. 403/122

(57) ABSTRACT

An improved method of manufacture for an isolated cross-axis ball joint, utilized in an articulated torque-rod end, wherein an isolated outer cylindrical element is chemically mold bonded to a pre-curled intermediate sleeve to provide isolation there from. The inner bearing element is comprised of a heat-treated spherical inner sleeve that rotates upon two lubricated plastic bearing races and two seals with encapsulated steel washers in each seal. The intermediate sleeve is pre-curled or manufactured at one end so as to retain a first seal. The first bearing race is then dropped in, followed by the heat-treated spherical inner sleeve, followed by the second ball race and the second seal. The second end of the intermediate sleeve is then fixed by compression and implementation of a retaining means, such as curling to close the bearing element. The seals provide the wear compensation of the ball joint by adding compression after the fixing of the intermediate sleeve.

### FIELD OF THE INVENTION

The present invention relates to the articulating device of a torque rod. More specifically, this invention relates to an improved articulated torque rod having a cross-axis ball joint with an elastomer retainer, and method of manufacturing the same.

### BACKGROUND OF THE INVENTION

Ball joints are often used in torque rods interposed between a wheel axle of a vehicle and a chassis thereof thereby to automatically adjust to the movement of the wheel axle relative to the chassis while the vehicle is running on rough or uneven roads. In the case of a torque rod, the ball is equipped with either a straddle mount or a taper pin which is attached to a spherical ball. The ball rotates within races, allowing the rod or assembly holding the ball races to rotate freely in three dimensions. A ball joint in a torque rod should be simple in its construction so as to be easily produced, and it should be smoothly operated and be capable of being used for a long period of time and further its life should be semipermanent.

There are numerous prior art patents utilizing ball joints in torque rods for a variety of uses. U.S. Pat. No. 3,451,700 issued to F. R. Smith teaches of a ball joint having a rubber seal for preventing foreign matter from damaging the articulating element, but requires additional means employed to apply pressure to the ball races, which increases manufacturing costs and time. U.S. Pat. No. 5,902,050 Issued to Balczun, et al show a ball joint end of a rod utilizing an isolating elastomer to minimize the transmission of vibration, but requires bonding the elastomeric isolation element to at least one surface of the ball joint.

The present invention provides for the manufacture of a superior isolated ball joint utilizing a simplified method of manufacturing and assembly, eliminating the need for bonding the isolating elastomer to the joint, and minimizing components, while still providing the desired isolation, ideal for use in articulated torque rods. Furthermore, the concepts covered herein utilize principles which easily apply to the manufacturing of isolated ball joints for use in bushings as well as torque rods.

### SUMMARY OF THE INVENTION

It is proposed herein that an object of the present invention is to provide a high articulation joint assembly.

A further object of the present invention is to provide a ball joint race design that adapts to the ball and race wear, while maintaining nearly constant spring pressure.

It is another object of the present invention to provide a dust boot, protecting the joint from the introduction of foreign matter, which is integral with the ball race spring.

Another object of the present invention is to provide a high articulation ball joint that can provide rigid response in one design iteration.

It is also an object of the present invention to provide a high articulation ball joint that further provides an elastomer isolator between the ball carrying device and the ball holding device.

Another object of the present invention is to provide a high articulation device that could be mounted as a straddle, taper pin, or through-hole ball joint known in the art.

It is another object of this invention to provide additional isolation of noise, vibration, and harshness between an axle and a frame by supplying the option of an articulation device isolated using a shock absorbent elastomer.

Finally, it is object of the present invention to eliminate the need for additional components for retaining the seals and adding compression to the bearing element.

The foregoing objects are achieved by a new method of manufacturing an improved articulated torque rod having a cross-axis ball joint with an elastomer retainer, and the resulting ball joint. In a first embodiment, the ball joint is located at the end of an articulating torque rod. Torque rods are generally manufactured from forged steel, cast iron, cast aluminum, or machined bar and tube, but could be manufactured from a variety of materials. Notwithstanding the manufacturing material, the torque rod end contains a cross-axial cylindrical hole with a lower restraining means either a disk, ring, snap ring or some other means such as forming a ledge from the bottom side of the torque rod cylinder wall. A lower ball race, manufactured from a synthetic material, preferably acetyl is then dropped in the cylindrical hole. The spherical ball component is then placed on the lower ball race, wherein an upper ball race is placed on top of the ball component.

The elastomer spring is then placed on top of the second ball race, wherein the elastomer spring and dust boot are molded in one continuous shape. It is additionally preferred in this embodiment that a steel retaining ring is molded into the elastomer spring. However, neither approach is essential to the invention. All three components could be independent.

Once the elastomer spring and retaining ring is in place, the entire assembly is fixed by adding another restraining device such as a snap ring, rolled edge, or formed metal edge. These restraining devices are put in place while the elastomer spring is under compression. When the assembly is released from the restraining fixture, the elastomer spring maintains the ball races to the ball under a predetermined, and measurable load.

In an alternative embodiment, the ball joint is modular for use as the inner component of an elastomer bushing. In this case, the ball joint is assembled as above, however in place of snap rings, alternatively, the assembly is contained within a thin-walled, intermediate cylinder. The cylinder ends are curled inward around the steel retaining rings, containing the articulating inner member and races. The cylinder can then be inserted into a torque rod end, along with an isolating rubber insert. The insert serves as a shock isolation device, and allows additional articulation of the inner metal if necessary.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partial perspective view of the articulating end of a torque rod end having a through-hole ball joint assembled consistent with the present invention contained there within;

FIG. 2 is a partial cross sectional side view of the articulated torque rod end of FIG. 1;

FIG. 3 is a partial cross sectional side view of an articulated torque rod end, having a taper-pin ball joint assembled consistent with the present invention contained therewith;

FIG. 4 is a cross sectional side view of the elastomer spring and incorporated dust boot of the articulated torque rod end of FIG. 3;

FIG. 5 is a cross sectional side view of a modular ball joint assembly comprising a second embodiment of the present invention, having a through-hole ball joint assembled consistent with the present invention contained there within;

FIG. 6 is a cross sectional side view of the intermediate and outer sleeves of the modular ball joint assembly of FIG. 5, prior to introduction and assembly with the ball joint; and

FIG. 7 is a cross sectional side view of the elastomer spring and incorporated dust boot of the modular ball joint assembly of FIG. 5.

### DETAILED DESCRIPTION OF THE PREFERRED EMBODIMENTS

The following description of the preferred embodiment(s) is merely exemplary in nature and is in no way intended to limit the invention, its application, or uses.

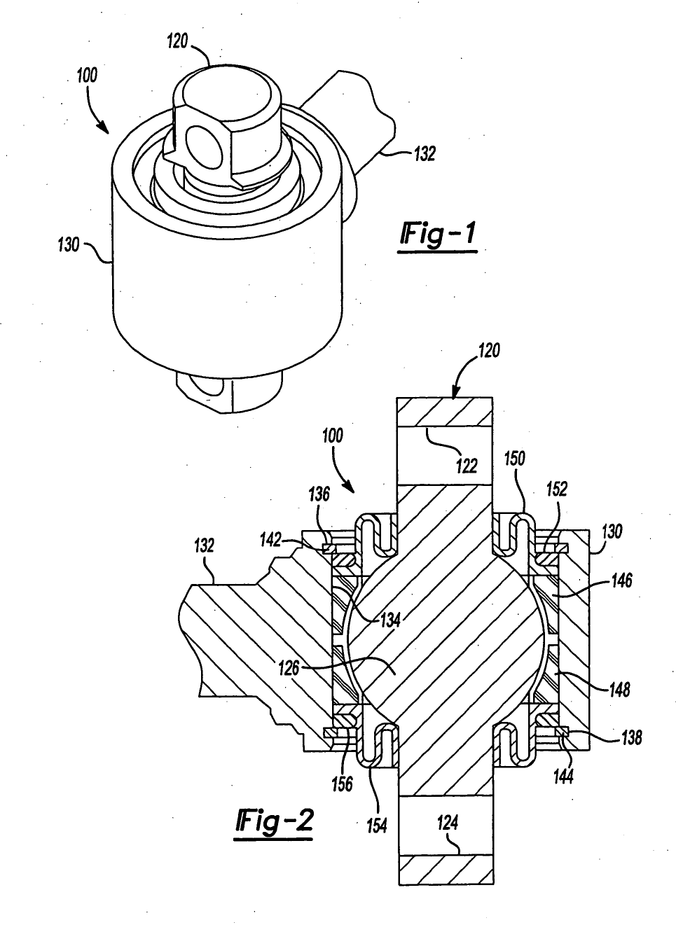

Referring initially to FIGS. 1 and 2, an articulated torque rod end having a through-hole ball joint 100 assembled consistent with the preferred embodiment of the present invention contained there within is shown. The ball joint 100 is located at the end 130 of an articulating torque rod 132, often used in automotive suspension systems. The torque rod end 130 is generally manufactured from forged steel, cast iron, cast aluminum, or machined bar and tube, but could be manufactured from a variety of materials. Regardless of the material, the torque rod end or housing 130 contains a cross-cylindrical bore 134 through which the ball joint 100 is locate.

In assembling the ball joint 100 into the torque rod end 130, a rigid, lower restraining means 144 comprising either a disk, ring, or snap ring is received in an annular grove 138 located at one end of the inner cylindrical bore 134 of the torque rod end 130. A first spring seal 150 is placed within the cylindrical bore 134 to rest upon the lower restraining means 144. The spring seal 150 comprises an elastomer ring with an encapsulated steel washer 156 attached thereto, and further embodies a convoluted dust shield 154 with an aperture there through, for snugly receiving and sealing the lower extension of a ball pin member 120 having a through bore 124, while allowing for the articulation of the ball joint. This spring seal 150 provides protection to the upper and lower ball races 146, 148 from foreign matter which would ordinarily cause premature wear or failure. The first ball race 148, manufactured from a synthetic material, preferably acetyl but not limited to such is then dropped in the cylindrical aperture, to rest upon the first spring seal 150.

The ball pin member 120, having spherical ball component 126 is manufactured of heat treated metal, or may embody a plastic over-molded sleeve not shown, for providing a plastic on plastic bearing joint. The ball component 126 is placed on the cradling first spherical ball race 148 so that the lower extension of the ball pin member 120 travels through the aperture in the first spring seal 150. An upper spherical ball race 146 is subsequently placed on top of the spherical ball component 126 of the ball pin member 120.

A second, identical elastomer spring seal 150 is installed, also having an upper, encapsulated steel washer 152 and molded convoluted dust shield 154 with an upper sealing aperture for snugly receiving and sealing the upper extension of a ball pin member 120, shown having through bore 122. This second spring seal 150 is placed over the upper extension of the ball pin member 120 and rests upon the second ball race 146 within the cylindrical bore 134. Once the second elastomer spring seal 150 is in place, the entire assembly is fixed by adding an upper restraining means 142 received within an upper annular groove 136 while the elastomer spring seal 150 is under compression. Once assembled, the elastomer spring seal 150 maintains the ball races 146, 148 to the spherical ball component 126 under high axial, or conical loads.

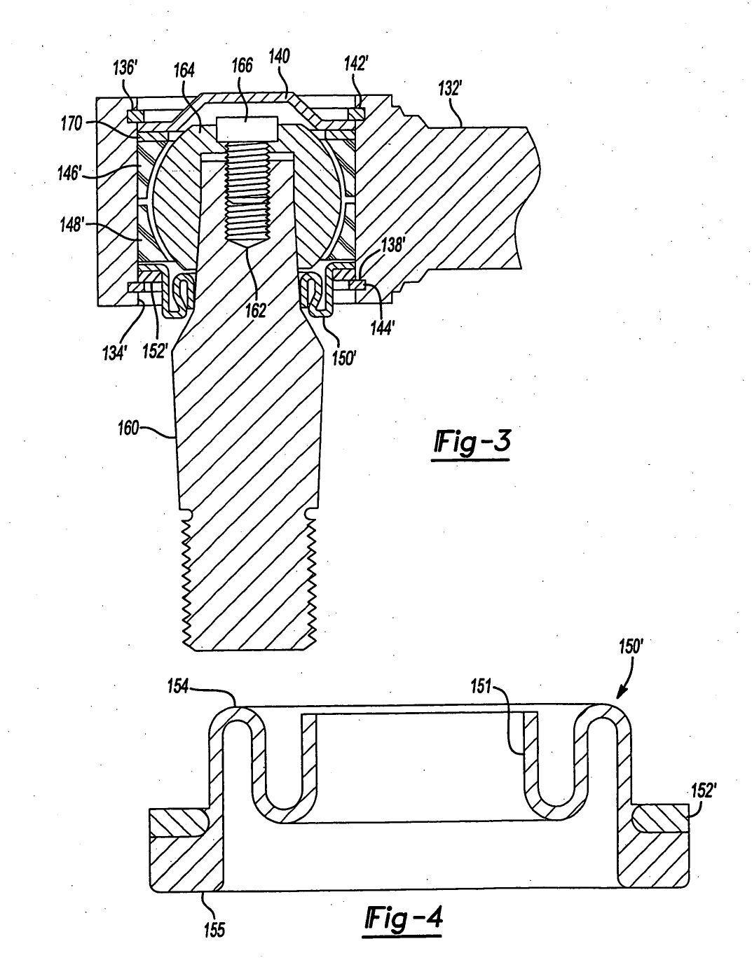

Referring now to FIGS. 3 and 4, a variation in the above embodiment is shown. In particular, an articulated torque rod end or housing 132′, utilizing a tapered ball pin member 160 which extends axially out of one end of the torque rod cylindrical bore 134′, having a threaded end and a tapered ball end for attachment to a generally spherical, inner ball member 164, through complimentary threaded attachment means 162 and 166. Additional methods of attachment including welding, forming, or crimping may be employed, as well as manufacturing the ball pin member 160 and inner ball member 164 as a single element which is known in the art and also intended to be compatible with the scope of this invention.

Assembly follows the above detailed description with a few exceptions. A rigid, upper restraining means 142′ comprising either a disk, ring, or snap ring is received in an annular grove 136′ located at one end of the inner cylindrical bore 134′ of the torque rod 132′. A retaining cap 140 is placed within the cylindrical bore 134′ to rest upon the upper restraining means 142′. The retaining cap 140 acts as a sealing member, keeping foreign material out of the ball joint, as well as providing a support means for supporting the ball joint once assembled under compression.

A spacer 170 and upper ball race 146′ is then placed in the cylindrical bore 134′, to rest upon the retaining cap 140. The ball pin member 160 having spherical inner ball member 164 is then placed within the bore 134′, cradled by the spherical ball race 146′. A lower spherical ball race 148′ is placed over the opposite side of the spherical inner ball member 164 on the ball pin member 160.

The elastomer spring seal 150′ shown enlarged in FIG. 4 for clarification, is installed over the lower ball race 148′ and embodies an encapsulated steel washer 152′ and convoluted dust shield 154 having a lower sealing aperture 151 for snugly receiving and sealing the extension of a ball pin member 160, while still allowing for the articulation of the ball joint. The spring seal 150′ is placed over the extension of the ball pin member 160, so that surface 155 comes to rest upon the lower axial surface of the lower ball race 148′ within the cylindrical bore 134′. Once the elastomer spring seal 150′ is in place, the entire assembly is fixed by adding a lower restraining means 144′ received within an lower annular groove 138′while the elastomer spring seal 150 is under compression. Once fixed, the elastomer spring seal 150 maintains the ball races 146, 148 to the spherical ball component 126 under high axial, or conical loads.

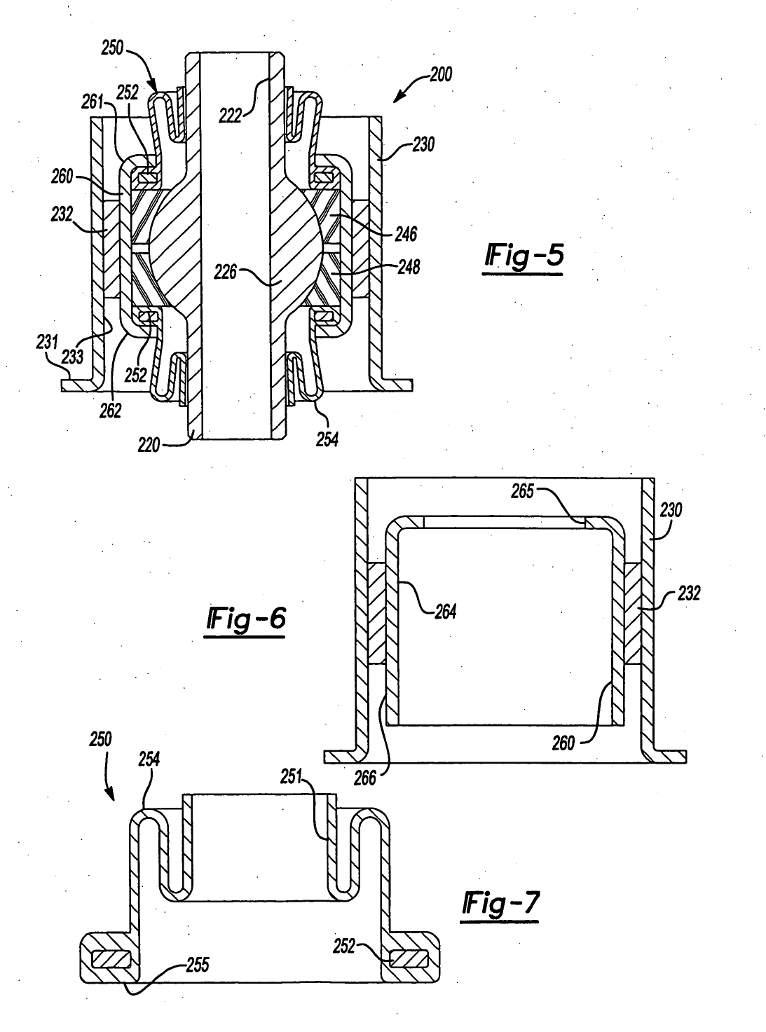

Referring now to FIGS. 5-7, an alternative embodiment of the present invention is shown, wherein the ball joint 200 is modular, comprising the inner component of an elastomer bushing. In this embodiment, the ball joint 200 is assembled as above, however in place of snap rings or other restraining means 144′ 142′, the assembly is contained within a thin walled housing or intermediate cylinder 260.

Particularly, the assembly of this embodiment consists of an isolated outer cylindrical sleeve 230, which may have one or more flanged ends 231 for retainment within a bushing or other application. The intermediate cylinder 260 is chemically mold-bonded coaxially within the inner bore 233 of the outer cylindrical sleeve 230 embodying resilient bushing 232. The insert serves as a vibrational shock isolation device, and allows additional articulation of the inner metal if necessary.

The intermediate cylinder 260 is pre-curled inward radially at one end 261 prior to molding, forming a radially inward flange 265 wherein a first spring seal 250 is placed within the cylindrical bore 264 to rest upon the flange 265. The spring seal 250 comprises an elastomer ring with an encapsulated steel washer 252 molded there within but not bonded to the spring seal 250, and further comprises a convoluted dust shield 254 end with an aperture 251 there through which snugly receives and seals the extension of a ball pin member 220 shown with through bore 222, wherein the dust shield 254 protects the first and second ball races 246 and 248 from foreign matter which would ordinarily cause premature wear or failure, while still allowing for articulation of the ball joint. The first ball race 246, also preferably manufactured from a synthetic material such as acetyl but not limited to such, is then dropped in the cylindrical aperture, to rest upon the first spring seal 250.

The ball pin member 220, having spherical ball component 226, is manufactured of heat treated metal, and optionally has a plastic over-molded sleeve not illustrated, for making a plastic on plastic bearing joint. The ball component 226 is placed on the cradling first spherical ball race 246 so that the extension of the ball pin member 220 travels through the aperture in the first spring seal 250. The second spherical ball race 248 is subsequently placed on top of the opposite side of the spherical ball component 226 on the ball pin member 220.

A second, identical elastomer spring seal 250 is installed, also having an encapsulated steel washer 256 and molded convoluted dust shield 254 with aperture 251 for snugly receiving and sealing a second extension of a ball pin member 220. This second spring seal 250 is placed over the upper extension of the ball pin member 220 and rests upon the second ball race 248 within the cylindrical bore 264. Once the second elastomer spring seal 250 is in place, the entire assembly is fixed by curling the second end 266 of the intermediate cylinder 260 inward, radially while simultaneously compressing the second elastomer spring seal 250 inward against the outer wall of the of the intermediate cylinder 260 forming flange 262, at the second end 266 of the intermediate cylinder 260. Once fixed, the elastomer spring seal 250 maintains the ball races 246, 248 to the spherical ball component 226 under high axial, or conical loads, while providing an articulating, isolated cross-axis ball joint. Additionally, any of the methods of seal retaining means described in the first embodiment above are intended to be applicable to this second embodiment including, though not limited to the use of snap rings, rolling or forming the edges of the intermediate cylinder 260.

It is of further importance that the description of the invention is merely exemplary in nature and, thus, variations that do not depart from the gist of the invention are intended to be within the scope of the invention. Such variations are not to be regarded as a departure from the spirit and scope of the invention.

What is claimed is:

1. An articulating joint comprising:
a housing defining a bore;
a ball pin member disposed within said bore;
a first and a second ball race disposed within said bore between said housing and said ball pin;
a first retainer disposed adjacent said first ball race, said first retainer closing a first end of said bore; and
a second retainer disposed adjacent said second ball race, said second retainer closing a second end of said bore.

2. The articulating joint according to claim 1, wherein said first retainer is a retaining cap and said second retainer is an elastomer seal ring.

3. The articulating joint according to claim 1, wherein said first and second retainers are each an elastomer seal ring.

4. The articulating joint according to claim 1, wherein said ball pin defines a spherical ball component and each of said first and second ball races define a spherical seat engaging said spherical ball component.

5. The articulating joint according to claim 4, wherein said first retainer is a retaining cap and said second retainer is an elastomer seal ring.

6. The articulating joint according to claim 4, wherein said first and second retainers are each an elastomer seal ring.

7. The articulating joint according to claim 1, wherein said first retainer is an elastomer seal ring.

8. The articulating joint according to claim 7, wherein said elastomer seal ring comprises a convoluted dust shield and an elastomeric ring having an encapsulated washer.

9. The articulating joint according to claim 1, wherein said first and second retainer are each an elastomer seal ring, said elastomer seal ring comprising a convoluted dust shield and an elastomeric ring having an encapsulated washer.

10. The articulating joint according to claim 1, further comprising a resilient bushing disposed around said housing and an outer cylindrical sleeve disposed around said resilient bushing.

11. The articulating joint according to claim 1, wherein said housing defines a first flange retaining said first retainer and a second flange retaining said second retainer.

12. The articulating joint according to claim 11, wherein said first and second retainer are each an elastomer seal ring, said elastomer seal ring comprising a convoluted dust shield and an elastomeric ring having an encapsulated washer.

13. The articulating joint according to claim 11, wherein said first and second retainers are each an elastomer seal ring.

14. The articulating joint according to claim 11, wherein said ball pin defines a spherical ball component and each of said first and second ball races define a spherical seat engaging said spherical ball component.

15. The articulating joint according to claim 14, wherein said first retainer is a retaining cap and said second retainer is an elastomer seal ring.

16. The articulating joint according to claim 14, wherein said first and second retainers are each an elastomer seal ring.

17. The articulating joint according to claim 11, wherein said first retainer is an elastomer seal ring.

18. The articulating joint according to claim 17, wherein said elastomer seal ring comprises a convoluted dust shield and an elastomeric ring having an encapsulated washer.

19. The articulating joint according to claim 11, wherein said first and second retainer are each an elastomer seal ring, said elastomer seal ring comprising a convoluted dust shield and an elastomeric ring having an encapsulated washer.

20. The articulating joint according to claim 11, further comprising a resilient bushing disposed around said housing and an outer cylindrical sleeve disposed around said resilient bushing.

21. A torque rod with elastomer retainer comprising:
a torque rod, said torque rod having at least one articulating end;
an articulating capsule, said articulating capsule comprising a ball and socket joint having a ball member and at least one corresponding race, said articulating capsule being located in said at least one articulating end of said torque rod;
an elastomer spring, said spring biasing the at least one corresponding race of said ball and socket joint against said ball member.

22. The torque rod with elastomer retainer of claim 21 wherein said elastomer spring further seals said articulating capsule from dirt and debris.

23. The torque rod with elastomer retainer of claim 21 wherein said articulating end comprises a cross-axial cylindrical hole wherein said articulating capsule is positioned there within.

24. A torque rod with elastomer retainer comprising:
a torque rod, said torque rod having at least one articulating end;
said articulating end comprising a cross-axial cylindrical hole wherein an articulating capsule is positioned there within;
an articulating capsule, said articulating capsule comprising a ball and socket joint having a ball member and at least one corresponding race, said articulating capsule being located in said at least one articulating end of said torque rod;
an elastomer spring, said elastomer spring biasing the at least one corresponding race of said ball and socket joint against said ball member, said elastomer spring further sealing said articulating capsule from dirt and debris.

25. A method of manufacturing a torque rod with elastomer retainer comprising the steps of:
forming a torque rod by means of manufacturing consisting of one of the following methods: forging casting or machining; said torque rod being formed with at least one cross-axial cylindrical bore there through at one end, said cross-axial bore further formed having an upper and lower interior retaining collar;
inserting a lower race retaining ring into said cylindrical bore;
inserting at least one lower race into said cylindrical bore, supported by said race retaining ring;
inserting a spherical ball component on to said at least one race;
inserting at least one upper race into said cylindrical bore, on top of said spherical ball component;
inserting an elastomer spring on top of said at least one upper race;
inserting an upper race retaining ring into said cylindrical bore;
compressing said elastomer spring against said at least one upper race;
inserting a restraining means while said elastomer spring remains under pressure, said restraining means consisting of one of the following: snap ring, rolled edge of said cylindrical wall, formed metal edge.

26. A ball joint comprising:
an outer cylinder, said outer cylinder being receivable in an articulating end of a torque rod;
an articulating capsule comprising an intermediate cylinder, said intermediate cylinder being chemically mold-bonded coaxially within said outer cylinder with a resilient vibration absorbing means bonded continuously around an outer surface of said intermediate cylinder, and the inner surface of said outer cylinder, said articulating capsule designed to retain a ball and socket joint having a generally spherical ball element, through which an inner cylinder is positioned, and a first and second convex ball race, complementary to the spherical ball race;
at least one elastomer retainer means, said elastomer retainer means being positioned within said intermediate cylinder, so as to provide a resilient force from a first end of said intermediate cylinder against said first ball race, further translating said force against said spherical ball, allowing for a finite degree of articulation of said ball element against said first ball race, said elastomer retainer means sealing said articulating capsule from dirt and debris.

27. The ball joint of claim 26, wherein said elastomer retaining means further comprises a steel washer encapsulated in said elastomer retaining means.

28. The ball joint of claim 26, wherein said elastomer retaining means is retained within said intermediate cylinder by curling the outer edges of the intermediate cylinder inward while simultaneously compressing the elastomer retaining means.

29. The ball joint of claim 26, wherein the elastomer retaining means is retained within said intermediate cylinder by means of a snap ring received in a groove machined on the inner bore of said intermediate cylinder.
